(19) United States
(12) Patent Application Publication
(10) Pub. No.: US 2003/0085300 A1
(43) Pub. Date: May 8, 2003

(54) Apparatus for sequentially distributing liquid in more than one direction and method thereof

(76) Inventor: Jean-Pierre Dautais, Bouguenais (FR)

Correspondence Address: ST. ONGE STEWARD JOHNSTON & REENS, LLC, 986 BEDFORD STREET, STAMFORD, CT, 06905-5619, US

(21) Appl. No.: 10/003,866

(22) Filed: Nov. 2, 2001

(51) Int. Cl. B05B 3/00

(52) U.S. Cl. 239/227

(57) ABSTRACT

The apparatus for sequentially distributing liquid in more than one direction, comprises a support and a reservoir connected to the support. The reservoir is rotatable and tiltable with respect to the support between a rest position where the liquid received therein accumulates and a flush position where liquid stored therein is flushed out via the spout. The spout is oriented such that the liquid flushing out of the reservoir causes by reaction a rotational movement of the reservoir with respect to the support. A counterweight is provided for urging the reservoir towards its rest position, the effect of the counterweight being cancelled when the liquid accumulated in the reservoir reaches a given quantity causing the reservoir to move towards its flush position and to rotate. Releasable stopping means are preferably provided for stopping sequentially the rotational movement of the reservoir in a number of successive radial positions around the support, each time the reservoir is tilted from its rest position to its flush position and is caused to rotate.

### FIELD OF THE INVENTION

The present invention is concerned with an apparatus and a method for sequentially distributing liquid in more than one direction. More particularly, it concerns an apparatus of the type comprising a tiltable and rotatable reservoir mounted in balance on a support, comprising an inlet for receiving liquid, an outlet for releasing liquid and means for guiding and stopping the reservoir sequentially in more than one direction around the support to distribute successively the liquid in a plurality of directions. This apparatus is suitable for use, for example, in the field of water treatment, water irrigation, etc. It could advantageously be used for directing and spreading waste water previously treated in a septic tank to different sanitary treating fields.

### BACKGROUND

Known in the art, there is the apparatus disclosed in EP0429365 by Mr. Dautais. The same inventor as in the present invention. The apparatus described in that document comprises a reservoir tube with unilateral discharge, supplied with liquid through a gully. The reservoir is mounted so that it can move both vertically and horizontally. The reservoir is normally held in an upper position by ballast whose effect is cancelled by the weight of liquid filing the tube. This causes the same to swing into a lower position and be emptied. This apparatus further comprises a rack cooperating with an outlet end of the reservoir and guiding the same into rotation step by step in the horizontal plane. The rack is formed of two complementary and spaced toothed rings outlining, between their facing surfaces, a guide for receiving the outlet end of the reservoir.

Also known in the art, there is the apparatus described in FR 2,724,724. The apparatus described therein is working substantially in the same way as the one described in EP0429365 as it uses a rack to make the reservoir rotate and perform a stepped rotation. In this case, the rack is cooperating with the base support to make the reservoir rotate.

One drawback with the above-mentioned documents of the prior art is that the use of a rack involving surfaces sliding in contact with each other to guide the reservoir implies the generation of a lot of frictions resisting to the rotation of the reservoir. Also, when these apparatuses are used for directing waste water, a problem of clogging may easily occur in the space between the rings of the rack.

Another drawback with these prior art apparatuses is that they do not provide any flexibility with regard to the adjustments of the different flushing directions. The different flushing directions possible are indeed directly limited to the actual design of the rack. For example, if a rack has been designed and produced for directing and stopping the reservoir in a given number of radial positions around the support, it is not possible afterwards to easily modify the rack so to add, delete or slightly adjust the different flushing directions.

There is still presently a need for a more flexible and efficient apparatus that would be relatively easy to upkeep and which could be made at a relatively low price.

The prior art documents FR2760816, U.S. Pat. No. 5,167,833 and U.S. Pat. No. 5,154,353 give other examples of multidirectional liquid distributors known in the art.

### SUMMARY OF THE INVENTION

An object of the present invention is to provide an apparatus that will satisfy at least one of these above-mentioned needs.

According to the present invention, that object is achieved with an apparatus for sequentially distributing liquid in more than one direction, the apparatus comprising:

a support;

a reservoir connected to the support, having an inlet for receiving liquid and a spout for releasing liquid, the reservoir being rotatable with respect to the support and tiltable with respect to the support between a rest position where the liquid received in the inlet accumulates in the reservoir and a flush position where liquid stored in the reservoir is flushed out via the spout, the spout being oriented such that the liquid flushing out of the reservoir causes by reaction a rotational movement of the reservoir with respect to the support; and

a counterweight for producing an effect of urging the reservoir towards its rest position, the effect of the counterweight being cancelled when the liquid accumulated in the reservoir reaches a given quantity causing the reservoir to move towards its flush position and to rotate.

In a preferred embodiment of the invention, the apparatus comprises releasable stopping means for stopping sequentially the rotational movement of the reservoir in a number of successive radial positions around the support, each time the reservoir is tilted from its rest position to its flush position and is caused to rotate.

According to another aspect of the present invention, there is also provided a method for sequentially distributing liquid in more than one direction, the method comprising the steps of:

continuously feeding liquid in an inlet of a reservoir mounted on a support, the reservoir being rotatable with respect to the support and tiltable between a rest position where the liquid received in the inlet accumulates in the reservoir and a flush position where liquid stored in the reservoir is flushed out via a spout, the spout being oriented such that the liquid flushing out of the reservoir causes by reaction a rotational movement of the reservoir with respect to the support;

urging the reservoir towards its rest position by means of a counterweight,

accumulating liquid in the reservoir to reach a given quantity of liquid canceling the effect of the counterweight and causing the reservoir to move towards its flush position and to rotate;

stopping sequentially the rotational movement of the reservoir in a number of said consecutive radial positions around the support.

According to a still further aspect of the invention, there is provided an apparatus for sequentially distributing liquid in more than one direction, the apparatus comprising:

a support;

a reservoir connected to the support, having an inlet for receiving liquid and a spout for releasing liquid, the reservoir being rotatable with respect to the support and tiltable with respect to the support between a rest position where the liquid received in the inlet accumulates in the reservoir and a flush position where liquid stored in the reservoir is flushed out via the spout, the spout being oriented such that the liquid flushing out of the reservoir causes by reaction a rotational movement of the reservoir with respect to the support; the reservoir is pipe shaped and has a flush side and an accumulation side opposite to each other with respect to the support, the spout being located on the flush side of the reservoir;

a counterweight located on the accumulation side of the reservoir for producing an effect of urging the reservoir towards its rest position, the effect of the counterweight being cancelled when the liquid accumulated in the reservoir reaches a given quantity causing the reservoir to move towards its flush position and to rotate;

an auxiliary reservoir interdependent to the accumulation side of the reservoir for receiving and accumulating liquid when the reservoir is in its rest position;

releasable stopping means for stopping sequentially the rotational movement of the reservoir in a number of successive radial positions around the support, each time the reservoir is tilted from its rest position to its flush position and is caused to rotate, the stopping means comprises:

a stop associated with the reservoir and projecting from under the flush side thereof; and

a plurality of circumferential abutment elements circumferentially positioned around the support for cooperating individually with the stop of the reservoir, one of said plurality of circumferential abutment elements being positioned at each one of said successive radial positions.

The objects, advantages and other features of the present invention will become more apparent upon reading of the following non-restrictive description of preferred embodiments thereof, given for the purpose of exemplification only with reference to the accompanying drawings.

### BRIEF DESCRIPTION OF THE DRAWINGS

FIG. 1 is a perspective view of an apparatus according to a first preferred embodiment of the invention;

FIG. 2 is a top view of the apparatus of FIG. 1, showing the reservoir in a first radial position around the support and, in dotted lines, in a second radial position consecutive to the first radial position;

FIG. 3 is a side view of the apparatus of FIGS. 1 and 2 along line III-III, showing the reservoir tilted in its rest position, in a first radial position, where liquid accumulates therein;

FIG. 4 is a side view of the apparatus of FIGS. 1 and 2 along line IV-IV, showing the reservoir tilted in its flush position, in a second radial position consecutive to the first radial position of FIG. 3, and where liquid is distributed in one direction;

FIG. 5 is a schematic side view of an apparatus according to a second preferred embodiment of the invention;

FIG. 6 is a schematic top view of the apparatus of FIG. 5;

FIG. 7 is a schematic top view of a reservoir preferably suitable for use with second preferred embodiment shown in FIG. 5;

FIG. 8 is a schematic side view of an apparatus according to a third preferred embodiment of the invention; and

FIG. 9 is a top view of the apparatus of FIG. 8.

### DESCRIPTION OF PREFERRED EMBODIMENTS

In the following description, similar features in the drawings have been given similar reference numerals and in order to weight down the figures, some elements are not referred to in some figures if they were already identified in a precedent figure.

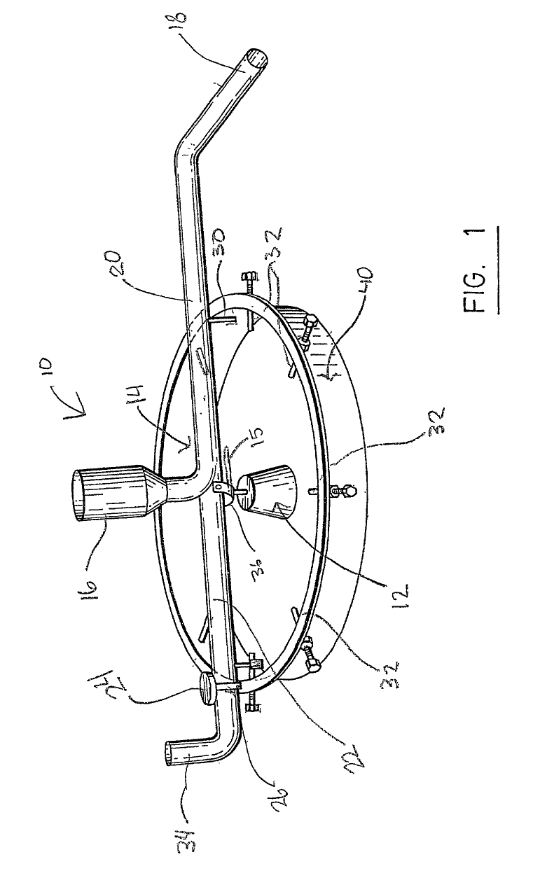

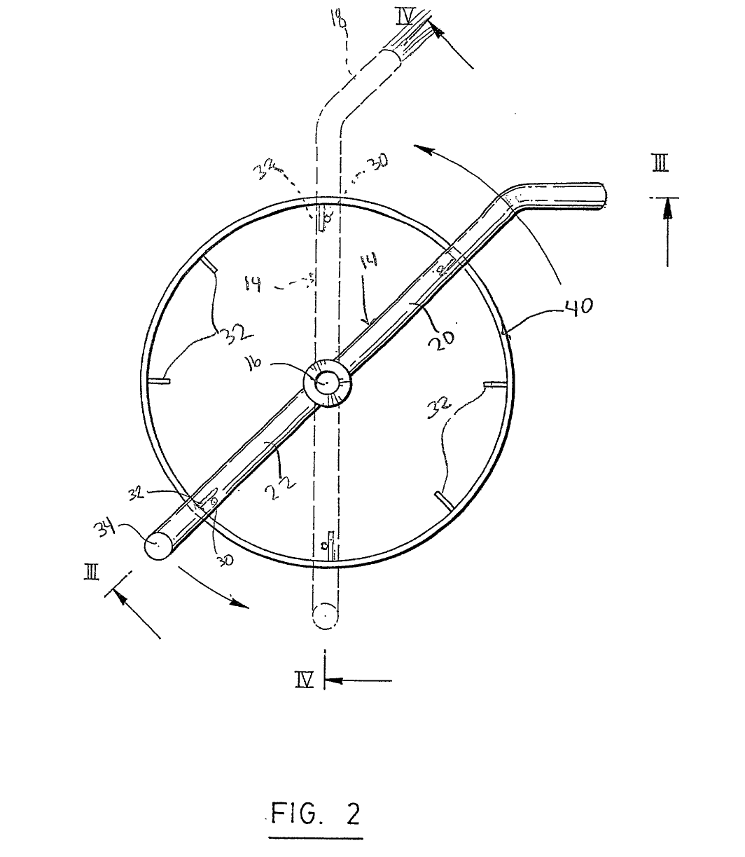

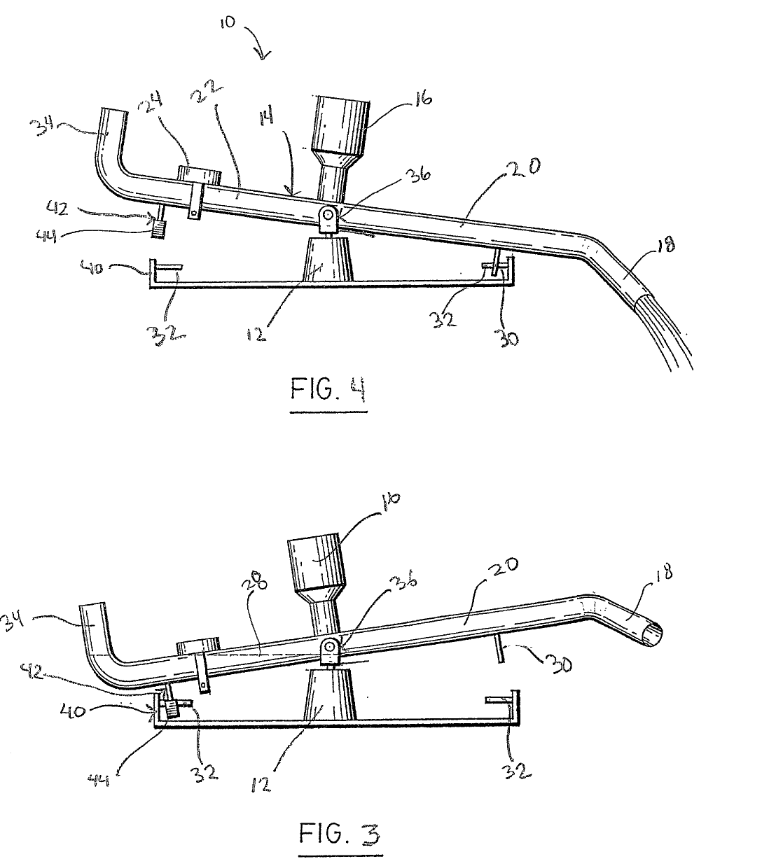

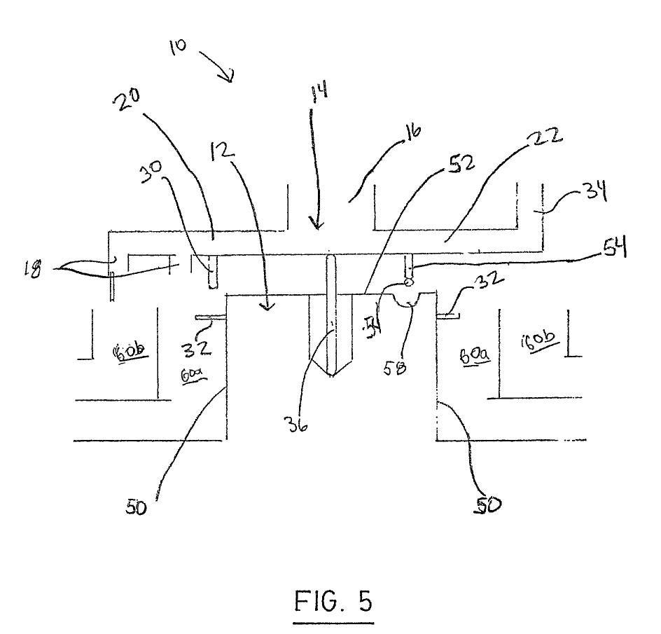

Generally described in reference to either one of FIGS. 1 and 5, which illustrate two different preferred embodiments of the invention, the apparatus (10) comprises a support (12) and a reservoir (14) connected to the support (12). The reservoir (14) has an inlet (16) for receiving liquid and a spout (18) for releasing liquid. The reservoir (14) is rotatable with respect to the support (12), as best shown for example in FIG. 2. It is also tiltable with respect to the support (12) between a rest position, as shown in FIG. 3, where the liquid received in the inlet (16) accumulates in the reservoir (14) and a flush position, as shown in FIG. 4, where liquid stored in the reservoir (14) is flushed out via the spout (18). As best seen in FIG. 1 or 2, the spout (18) is oriented such that the liquid flushing out of the reservoir (14) causes by reaction a rotational movement of the same with respect to the support (12). In the embodiment illustrated, the reservoir (14) is preferably elongated and the spout (18) is oriented so as to direct the liquid released therefrom obliquely to the side and the bottom with respect to a longitudinal axis of the reservoir (14). This orientation of the spout (18) can be best appreciated when FIGS. 2 and 3 or 4 are viewed in combination. It is worth noting however that the spout (18) is not limited to this particular shape. In fact, it can take any shape that would allow the reservoir (14) to rotate by reaction of the liquid flushing out from the spout (18). For example, in another embodiment of the invention not illustrated, the spout (18) could be oriented perpendicularly with respect to the longitudinal axis of the reservoir (14). It is also worth mentioning that the spout (18) is preferably adjustable. In other words, it could be adjusted to be oriented in different direction. It could also be provided with an adjustable poppet valve to control the flow of liquid. The reservoir (14) is also not limited to the particular shape illustrated. It does not have to be an elongated reservoir (14).

The apparatus (10) further comprises a counterweight for producing an effect of urging the reservoir (14) towards its rest position, as in FIG. 3. The effect of the counterweight is cancelled when the liquid accumulated in the reservoir (14) reaches a given quantity causing, as in FIG. 4, the reservoir (14) to move towards its flush position and to rotate. In the preferred embodiment illustrated, the reservoir (14) is pipe shaped and it comprises a flush side (20) and an accumulation side (22) opposite to each other with respect to the support (12), the spout (18) being located on the flush side (20) of the reservoir (14). In such a case, the accumulation side (22) of the reservoir (14) by itself could have acted as the counterweight provided that it is heavier than the flush side (20) of the reservoir (14) when the same is emptied. However, in the preferred embodiments illustrated, the counterweight preferably comprises a ballast (24) located on the accumulation side (22) of the reservoir. For adjustment purposes, the ballast (24) is preferable slidably mounted to the reservoir (14) by means of a conventional collar (26). As can be appreciated, when there is no liquid accumulated in the reservoir (14), the centre of gravity of the reservoir (14) is located on the accumulation side (22) because of the counterweight (24). When liquid is received in the inlet (16), it is directed towards the accumulation side (22) of the reservoir (14). Then, when liquid is further received, it accumulates in the reservoir (14) and the centre of gravity of the reservoir (14) gradually moves with the front line of the liquid (28), as shown in FIG. 3, towards the flush side (20) until the reservoir (14) is caused to tilt in its flush position.

The apparatus (10) preferably comprises releasable stopping means for stopping sequentially the rotational movement of the reservoir (14) in a number of successive radial positions around the support (12), each time the reservoir (14) is tilted from its rest position to its flush position and is caused to rotate. The reservoir (14) illustrated in FIG. 2 is shown in two of these radial positions, a first position, in solid lines, and a second position in dotted lines. In both embodiments illustrated in either one of FIGS. 1 or 5, the stopping means preferably comprises a stop (30) associated with the reservoir (14) and projecting from under the flush side (22) thereof and a plurality of circumferential abutment elements (32) circumferentially positioned around the support (12) for cooperating individually with the stop (30) of the reservoir (14). One of these abutment elements (32) is positioned at each one of the successive radial positions of the reservoir (14), as best shown in FIG. 2. The apparatus (10) shown in FIG. 2 includes height of these abutment elements (32). However, it is to be understood that the apparatus (10) according to the invention may comprise any number of abutment elements (32) for distributing the liquid in as many directions as required.

As will be more fully described herein below, the abutment elements (32) could be designed so as to be easily mountable and adjustable around the support (12) thereby providing more flexibility to the user who wishes to adjust the different flowing directions of the liquid around the support (12) or who wishes to add or remove one or more of these flowing directions.

Although, the preferred embodiment of the invention illustrated comprises releasable stopping means as described above, it is worth noting that in another embodiment of the invention not illustrated, the apparatus may not be provided with a releasable stopping means. In such a case, the rotational movement of the reservoir (14) may be stopped simply by the effect of the friction between the different elements of the apparatus.

The apparatus (10) also preferably comprises means for limiting a course of the reservoir (14) between the rest position and the flush position. In the first preferred embodiment illustrated in FIG. 1, the means for limiting the course of the reservoir (14) preferably consists of a leaf (15) more preferably, a spring leaf, connected to the universal coupling (36). The reservoir (14) rests on the spring leaf when it is in the flush position. The spring leaf also helps avoiding the friction between the under side of the reservoir and the rim (40).

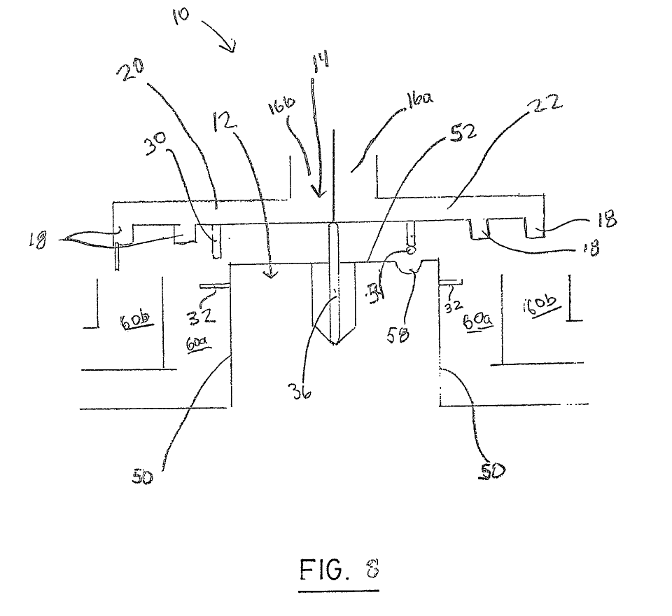

Referring to any one of FIGS. 1 to 6, the inlet (16) of the reservoir (14) is preferably located on a central part of the reservoir (14) between the accumulation side (22) and the flush side (20). This positioning of the inlet (16), although not necessary to the invention, helps to properly and more easily adjust the balance of the reservoir (14). The inlet (16) is also preferably oriented upwardly for receiving liquid from above the reservoir (14). More preferably, the inlet (16) is a gully shaped container, as shown in FIG. 1. In order to reduce the height of the apparatus (10) without limiting to much its capacity to receive and distribute liquid, the gully shaped container (16) is preferably a shallow container capable of accumulating a large quantity of liquid compared to the reservoir (14) itself, as shown for example in FIG. 7. This shallow container (16) is also particularly suitable when the feeding of liquid is at low-rate.

Referring to any one of FIGS. 1 to 5, the apparatus (10) also preferably comprises an auxiliary reservoir (34) interdependent to the accumulation side (22) of the reservoir (14) for further receiving and accumulating liquid when the reservoir (14) is in its rest position, as best shown for example in FIG. 3. Such an auxiliary reservoir (34) contribute to increase the power of the jet of liquid coming out from the spout (18) and thus to increase by reaction the angular acceleration and speed of the reservoir (14) with respect to the support (12). The auxiliary reservoir (14) in the embodiments illustrated is preferably located at an extremity of the accumulation side (22) opposite the flush side (20). It is preferably an extension of the accumulation side (22) extending upwardly with respect to the same. It is worth noting that in another embodiment of the invention not illustrated, the auxiliary reservoir (34) may have taken another shape as long as it makes it possible to further accumulate liquid on the accumulation side (22) of the reservoir (14) and thus to increase the power of the jet of liquid exiting the spout (18). For example, in order to limit the height of the apparatus (10), the auxiliary reservoir (34) could have taken the shape of a T-shaped extension at the extremity of the accumulation side (22).

Turning now to FIGS. 1, 3 and 4, the reservoir (14) is mounted on a base support (12) by means of a universal coupling (36) having the shape of a stirrup. It is however worth noting that the invention is not limited to this particular construction. For example, in another embodiment of the invention not illustrated the reservoir (14) could have been suspended to the support (12) by means of a universal joint.

In the first preferred embodiment, the apparatus (10) comprises a rim structure (40) encircling the support (12). In this case, the circumferential abutment elements (32) are associated to the rim structure (40). They consist of abutment rods projecting inwardly towards the support (12) for cooperating individually and sequentially with the stop (30) projecting from under the reservoir (14) to releasably stop the reservoir (14) in a number of successive radial positions around the support (12), each time the reservoir (14) is tilted from its rest position to its flush position and is caused to rotate. As best seen in FIG. 3 in combination with FIG. 2, one can see that the stop (30) projecting from under the reservoir (14) is released from the abutment elements (32) when the reservoir (14) is in its rest position. Then, when the reservoir (14) is caused to move to its flush position and to rotate by reaction of the liquid flushing out of the spout (18), the stop (32) projecting from under the reservoir (14) gets in contact with the next abutment element (32), as shown in FIG. 4, thereby stopping the rotational movement of the reservoir (14) with respect to the support (12) and positioning the same in a specific radial position. The abutment elements (32) are either removably secured to the rim (40), as shown in FIG. 1, or they could also be permanently mounted to the rim (40). They could also be made integral to the rim (40).

Preferably, in order to clear the stop (30) from the last abutment element (32) used in a sequence and prevent the stop (30) from abutting the same abutment element (32) the next time the reservoir (14) moves to its flush position, the apparatus (10) also comprises an adjustment means for slightly rotating the reservoir (14) forward with respect to the last radial position.

The adjustment means may be the spout (18) itself oriented so to cause by reaction an immediate rotation of the reservoir (14) as soon as the reservoir (14) starts to move towards its flush position. In the preferred embodiment illustrated in FIGS. 1 to 4, the adjustment means comprises an arrow-shaped rod (42) located on the accumulation side (22) and projecting from under the reservoir (14). This arrow-shaped rod (42) has a head (44) pointed towards the bottom adapted to cooperate with the abutment elements (32) to slightly rotate the reservoir (14) forward with respect to the last radial position when the reservoir (14) is tilted from its flush position to its rest position.

In order to limit the friction between the rim (40) and the underside of the reservoir (14), the apparatus may alternatively comprise a wheel (not illustrated) operatively connected to the underside of the reservoir (14) on the flush side (20) thereof.

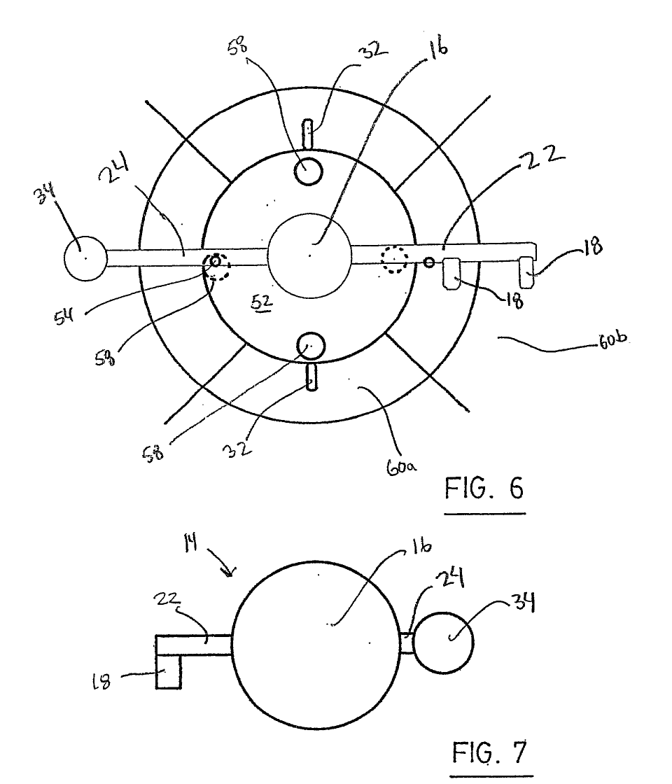

Referring now to FIGS. 5 and 6 illustrating schematically a second preferred embodiment of the invention, the base support (12) may take the shape of a cylindrical base support (12) with a vertical side wall (50) and a circular top wall (52). In this embodiment, the abutment elements (32) are associated to the base support (12), more specifically to the side wall (50) thereof. As best shown in FIG. 5, the abutment elements (32) preferably consist of abutment rods projecting outwardly from the side wall (50) of the base support (12). Each of these abutment rods is positioned to individually cooperate with the stop (30) projecting from under the reservoir (14). This embodiment also comprises a support leg (54) projecting from under the reservoir (14) on the accumulation side (22) thereof. This support leg (54) is intended to lean on the top wall (52) of the base support (16) when the reservoir (14) is in its rest position and thereby prevents the accumulation side (22) of the reservoir (14) from getting directly in contact with the base support (12), which would cause a lot of friction between these parts. This support leg (54) helps limiting the course of the reservoir (14) when it is in the rest position.

In this preferred embodiment, the adjustment means, discussed above, for slightly rotating the reservoir (14) forward with respect to its last radial position comprises a roller (56) provided at the tip of support leg (54). The adjustment means further comprises a plurality of recesses (58) provided on the top wall (52) of the base support (12), each of these recesses (58) being adapted, on one side, to receive the roller (56) of the support leg (54) when the reservoir (14) moves to its rest position and, on the other side, to cooperate with the same to rotate slightly the reservoir (14) forward.

As can be appreciated from FIGS. 1 and 5, the apparatus (10) according to the invention may comprise only one spout (18) or, it could comprise more than one spout, as shown in FIG. 5. In this last case, the apparatus (10) comprises two annular reception containers (60a, 60b) encircling the base support (10) to receive the liquid release from a corresponding one of said two spouts (18). In another embodiment of the invention not illustrated, the apparatus (10) may advantageously comprise as many number of spouts (18) as required. One would understand that in such a case, the apparatus (10) would preferably comprise as many of annular reception containers (60) as the spouts (18). Each reception container (60), individually, may be shaped such that the liquid received therein converged towards a single outlet.

Although not clearly illustrated in FIG. 5, the reservoir (14) is preferably connected to the base support (12) by means of a universal coupling (36) similar to the one used with the apparatus (10) shown in FIG. 1 and which has been described above.

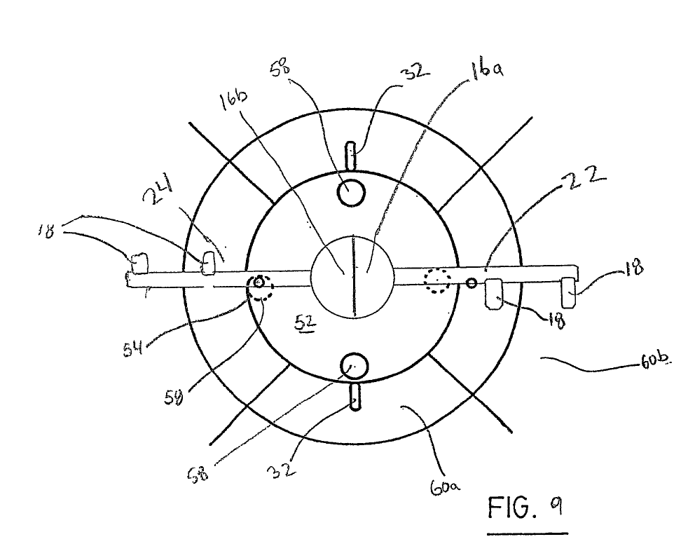

A third preferred embodiment of the invention is illustrated in FIGS. 8 and 9. The apparatus in this case comprises spouts on both sides (20, 24) of the base support and the inlet reservoir comprises a partition wall (17) dividing the inlet reservoir in two parts (16a, 16b).

The whole apparatus could be made of standard components made of plastic. The components are preferably made of PVC.

As can be appreciated, the apparatus according to the invention provides more flexibility to the user, it is extremely simple and inexpensive to build and to maintain. It is not cumbersome and it could be very light when components made of plastics such as PVC are used.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. An apparatus for sequentially distributing liquid in more than one direction, the apparatus comprising:
a support;
a reservoir connected to the support, having an inlet for receiving liquid and a spout for releasing liquid, the reservoir being rotatable with respect to the support and tiltable with respect to the support between a rest position where the liquid received in the inlet accumulates in the reservoir and a flush position where liquid stored in the reservoir is flushed out via the spout, the spout being oriented such that the liquid flushing out of the reservoir causes by reaction a rotational movement of the reservoir with respect to the support; and
a counterweight for producing an effect of urging the reservoir towards its rest position, the effect of the counterweight being cancelled when the liquid accumulated in the reservoir reaches a given quantity causing the reservoir to move towards its flush position and to rotate.

2. An apparatus as claimed in claim 1, comprising:
releasable stopping means for stopping sequentially the rotational movement of the reservoir in a number of successive radial positions around the support, each time the reservoir is tilted from its rest position to its flush position and is caused to rotate.

3. An apparatus as claimed in claim 2, wherein the stopping means comprises:
a stop associated with the reservoir; and
a plurality of circumferential abutment elements circumferentially positioned around the support for cooperating individually with the stop of the reservoir, one of said plurality of circumferential abutment elements being positioned at each one of said successive radial positions.

4. An apparatus as claimed in claim 3, wherein the stop is a rod projecting from under the reservoir.

5. An apparatus as claimed in claim 4, comprising a rim structure encircling the support, the circumferential abutment elements being associated to the rim structure.

6. An apparatus as claimed in claim 3, wherein the support is a base support on which is mounted the reservoir.

7. An apparatus as claimed in claim 6, wherein the base support has a cylindrical shape, the abutment elements being associated to the base support.

8. An apparatus as claimed in claim 1, wherein the reservoir is pipe shaped.

9. An apparatus as claimed in claim 1, comprising:
means for limiting a course of the reservoir between the rest position and the flush position.

10. An apparatus as claimed in claim 1, wherein the reservoir has a flush side and an accumulation side opposite to each other with respect to the support, the spout being located on the flush side of the reservoir and the counterweight being located on the accumulation side of the reservoir.

11. An apparatus as claimed in claim 10, wherein the inlet is located on a central part of the reservoir between the accumulation side and the flush side.

12. An apparatus as claimed in claim 1, wherein the inlet is oriented upwardly for receiving liquid from above the reservoir.

13. An apparatus as claimed in claim 12, wherein the inlet is a gully shaped container.

14. An apparatus as claimed in claim 10, comprising an auxiliary reservoir interdependent to the accumulation side of the reservoir for receiving and accumulating liquid when the reservoir is in its rest position.

15. An apparatus as claimed in claim 14, wherein the auxiliary reservoir is located at an extremity of the accumulation side opposite the flush side.

16. An apparatus as claimed in claim 15, wherein the auxiliary reservoir is pipe shaped and extends upwardly with respect to the accumulation side.

17. An apparatus as claimed in claim 1, comprising more than one spout.

18. A method for sequentially distributing liquid in more than one direction, the method comprising the steps of:
continuously feeding liquid in an inlet of a reservoir mounted on a support, the reservoir being rotatable with respect to the support and tiltable between a rest position where the liquid received in the inlet accumulates in the reservoir and a flush position where liquid stored in the reservoir is flushed out via a spout, the spout being oriented such that the liquid flushing out of the reservoir causes by reaction a rotational movement of the reservoir with respect to the support;
urging the reservoir towards its rest position by means of a counterweight,
accumulating liquid in the reservoir to reach a given quantity of liquid canceling the effect of the counterweight and causing the reservoir to move towards its flush position and to rotate;
stopping sequentially the rotational movement of the reservoir in a number of said consecutive radial positions around the support.

19. An apparatus for sequentially distributing liquid in more than one direction, the apparatus comprising:
a support;
a reservoir connected to the support, having an inlet for receiving liquid and a spout for releasing liquid, the reservoir being rotatable with respect to the support and tiltable with respect to the support between a rest position where the liquid received in the inlet accumulates in the reservoir and a flush position where liquid stored in the reservoir is flushed out via the spout, the spout being oriented such that the liquid flushing out of the reservoir causes by reaction a rotational movement of the reservoir with respect to the support; the reservoir being pipe shaped and having a flush side and an accumulation side opposite to each other with respect to the support, the spout being located on the flush side of the reservoir;
a counterweight located on the accumulation side of the reservoir for producing an effect of urging the reservoir towards its rest position, the effect of the counterweight being cancelled when the liquid accumulated in the reservoir reaches a given quantity causing the reservoir to move towards its flush position and to rotate;
an auxiliary reservoir interdependent to the accumulation side of the reservoir for receiving and accumulating liquid when the reservoir is in its rest position;
releasable stopping means for stopping sequentially the rotational movement of the reservoir in a number of successive radial positions around the support, each time the reservoir is tilted from its rest position to its flush position and is caused to rotate, the stopping means comprises:
a stop associated with the reservoir and projecting from under the flush side thereof; and
a plurality of circumferential abutment elements circumferentially positioned around the support for cooperating individually with the stop of the reservoir, one of said plurality of circumferential abutment elements being positioned at each one of said successive radial positions.

20. An apparatus as claimed in claim 1, wherein the support is a base support on which is mounted the reservoir.
